(19) United States
(12) Patent Application Publication
(10) Pub. No.: US 2006/0153169 A1
(43) Pub. Date: Jul. 13, 2006

(54) Customer premises network with PSTN and packet telephony functions

(75) Inventors: Gil Koifman, Petach Tikva (IL); Ronen Bartal, D.N. Emek Hefer (IL)

Correspondence Address: WELSH & KATZ, LTD, 120 S RIVERSIDE PLAZA, 22ND FLOOR, CHICAGO, IL, 60606, US

(73) Assignee: SMARTLINK LTD., Netanya (IL)

(21) Appl. No.: 11/301,505

(22) Filed: Dec. 13, 2005

Related U.S. Application Data
(60) Provisional application No. 60/634,924, filed on Dec. 13, 2004.

(51) Int. Cl. H04L 12/66

(52) U.S. Cl. 370/352

(57) ABSTRACT

A method for telephony includes modulating output audio signals produced by first and second telephones in a voice band so as to generate respective first and second upstream passband signals in a passband at a frequency higher than the voice band. The first and second upstream passband signals are transmitted to a telephony gateway, which couples the first telephone to communicate via a telephone line over a circuit-switched telephone network and couples the second telephone, via a data interface of the telephony gateway, to communicate over a packet network.

### CROSS-REFERENCE TO RELATED APPLICATION

This application claims the benefit of U.S. Provisional Patent Application 60/634,924, filed Dec. 13, 2004, which is incorporated herein by reference.

### FIELD OF THE INVENTION

The present invention relates generally to computer-integrated telephony, and specifically to methods and devices for integrating packet-switched and circuit-switched telephone equipment and services.

### BACKGROUND OF THE INVENTION

Analog telephone adapters are devices that convert the analog signals from a conventional telephone into a format acceptable for transmission over an Internet connection, and vice versa at the receiving end. A variety of products of this sort are available on the market. Examples include the HandyTone series, produced by Grandstream Networks; Sipura Phone Adapters, produced by Sipura Technology, Inc. (recently acquired by Cisco Systems); Quadro® Voice Routers, produced by Epygi® Technologies, Ltd.; FXS VoIP Gateway, produced by Micronet®; Messenger Call Box, produced by BAFO Inc.; Actiontec® Internet Phone Wizard, produced by Actiontec Electronics, Inc.; and M3 Motorola® Messenger Modem, produced by Motorola, Inc.

Various types and features of analog telephone adapters are described in the patent literature. For example, U.S. Pat. No. 6,700,956, whose disclosure is incorporated herein by reference, describes apparatus for selectively connecting a telephone to a telephone network or to the Internet. The apparatus comprises a hardware module and associated software for coupling a personal computer or Internet appliance and a standard analog telephone. The apparatus permits the analog telephone to be toggled between an Internet-based telephone mode and a public switched telephone network (PSTN) mode by inputting a predetermined sequence of dual-tone multi-frequency (DTMF) digits.

U.S. Pat. No. 6,731,751, whose disclosure is incorporated herein by reference, describes interface apparatus, which is interposed between a cordless telephone base unit and a personal computer sound card. The interface emulates a central office connection with respect to the telephone and a microphone and speaker connection with respect to the computer sound card.

U.S. Pat. No. 6,711,160, whose disclosure is incorporated herein by reference, describes an interface unit between a telephone and a packet network. The unit also functions as a gateway between a packet network and a public switched telephone network (PSTN). When power is not supplied to the unit, a fallback switch automatically links the telephone instrument directly to the PSTN, bypassing the circuitry in the unit. The unit also includes an LCD driver and a display for showing information such as caller identification.

U.S. Pat. No. 6,345,047, whose disclosure is incorporated herein by reference, describes a computer telephony adapter, which permits simultaneously sending a telephone call from a telephone and IP packets from a computer, both over the same subscriber line. The adapter converts signals from the telephone terminal into IP packets. A multiplexer simultaneously sends the IP packets representing the telephone call and those from the computer along the subscriber line.

U.S. Pat. No. 6,724,871, whose disclosure is incorporated herein by reference, describes a system and method for adding multiple line capabilities to existing customer premises wiring. The system exploits an unused internal telephone line to provide a logical telephone line for a telephone station coupled to a personal computer, which is coupled to a high-bandwidth channel. In this manner, two telephone numbers can be assigned to the premises: one for analog telephone service and one for packetized digital service using digital subscriber line (DSL) service over a telephone wire between a central office and the customer premises. The analog telephone service and the packetized digital telephone service may be used simultaneously.

The Home Phoneline Networking Alliance (HomePNA) has defined standards that permit home computers to be networked over existing telephone wiring. The networking function operates in a frequency band above voice, analog modem and DSL modem, allowing one phone line to be used for regular telephone conversations. 2Wire Inc. (San Jose, Calif.) offers the HomePortal® residential gateway, which is compatible with HomePNA and includes an ADSL modem and router with integrated voice over IP (VoIP).

### SUMMARY OF THE INVENTION

Embodiments of the present invention provide improved systems and methods for providing both circuit-switched and packet telephone services using conventional analog telephones. The disclosed systems comprise a central gateway, which serves one or more telephones in customer premises. The gateway is connected both to a packet network, such as the Internet, and to a telephone line of a circuit-switched telephone network, which is typically used to carry circuit-switched telephone calls in the conventional voice band. The telephones are coupled to communicate with the central gateway via novel telephone adapters, which may be connected between the telephone and the telephone line.

The adapters modulate audio output signals generated by the telephone for transmission to the gateway as passband signals, at frequencies higher than the voice band, and similarly receive and demodulate passband signals from the gateway to generate audio input signals to the respective telephones. In some embodiments, these passband signals are carried over the telephone line between the adapters and the gateway. The gateway is configured to place and receive packet telephone calls, such as Voice over Internet Protocol (VoIP) calls, and may also be configured to place and receive calls over the circuit-switched network. The telephones thus serve as user interface devices for packet calls and for circuit-switched calls placed and received via the gateway. Multiple telephones, with respective adapters, may be used in conjunction with the gateway to conduct packet and circuit-switched telephone calls simultaneously. The gateway thus provides a sort of logical private branch exchange (PBX) function.

In some embodiments, the telephone adapter comprises a switch, which is capable of coupling the telephone directly to the telephone line, thus permitting the telephone to place and receive telephone calls directly over the telephone line to and from the circuit-switched telephone network at voice-band frequencies. This mode of operation of the telephone adapters can be used to bypass the gateway if and when necessary or otherwise desired.

Typically, the gateway is connected to the packet network by a broadband link. In some embodiments, this link comprises a digital subscriber line (DSL) connection, which may use the same telephone line as is used for carrying the voice-band telephone calls and, optionally, the passband signals that are transmitted between the telephones and the gateway. In this manner, existing telephone wiring in the customer premises may be exploited for both circuit-switched and packet telephone services with the sort of distributed functionality described above.

There is therefore provided, in accordance with an embodiment of the present invention, a system for telephony, including:

a plurality of telephone adapters, each of which is configured to be coupled to a telephone and to modulate output audio signals produced by the telephone in a voice band so as to generate upstream passband signals for transmission in a passband at a frequency higher than the voice band, and to receive and demodulate downstream passband signals so as to generate input audio signals to the telephone; and

a telephony gateway, which is adapted to receive and demodulate the upstream passband signals and to generate and transmit the downstream passband signals to the telephone adapters, and which includes a line interface for coupling to a telephone line of a circuit-switched telephone network and a data interface for coupling to a packet network, and which is operative to process the passband signals so as to couple a first telephone, via a first telephone adapter and the telephone line, to communicate over the circuit-switched telephone network, while coupling a second telephone, via a second telephone adapter and the data interface, to communicate over the packet network.

In some embodiments, the telephone adapters are arranged to be coupled to the telephone line, and are operative to exchange the upstream and downstream passband signals with the telephony gateway via the telephone line. In a disclosed embodiment, each of the telephone adapters includes a respective switch, which is operable to connect the telephone to the telephone line so as to permit the telephone to communicate over the circuit-switched network by conveying the input and output audio signals between the telephone and the telephone line.

In some embodiments, the telephony gateway is operative to couple the first telephone to communicate over the circuit-switched network via the line interface of the telephone gateway. Additionally or alternatively, the telephony gateway is operative to establish a Voice over Internet Protocol (VoIP) call between the second telephone and the packet network.

In another embodiment, the telephone adapters and the telephony gateway are adapted to transmit and receive the upstream and downstream passband signals over the air.

In a disclosed embodiment, the upstream and downstream passband signals are modulated using an analog modulation scheme.

In some embodiments, the telephony gateway includes a digital subscriber line (DSL) modem, which is coupled between the data interface and the telephone line and is operative to connect the telephony gateway to the packet network by transmitting and receiving DSL signals over the telephone line. Typically, the DSL modem is operative to transmit and receive the DSL signals in a DSL frequency band, and the telephone adapters are operative to exchange the upstream and downstream passband signals with the telephony gateway via the telephone line, such that the frequency of the passband in which the telephone adapters and the telephony gateway transmit the upstream and downstream passband signals is higher than the DSL frequency band.

In a disclosed embodiment, the passband includes at least first and second sub-bands, which are respectively assigned to the first and second telephone adapters for use in communicating simultaneously with the telephony gateway.

There is also provided, in accordance with an embodiment of the present invention, a system for telephony, including:

at least one telephone adapter, which is configured to be coupled to a telephone and to a telephone line of a circuit-switched telephone network, and which includes:
signal processing circuitry, which is operative to modulate output audio signals produced by the telephone in a voice band so as to generate upstream passband signals for transmission in a passband at a frequency higher than the voice band, and to receive and demodulate downstream passband signals so as to generate input audio signals to the telephone; and
a switch, having a first configuration in which the telephone is connected to the telephone line so as to permit the telephone to communicate via the telephone line over the circuit-switched telephone network, and a second configuration in which the signal processing circuitry is connected between the telephone and the telephone line so as to transmit and receive the upstream and downstream passband signals over the telephone line; and

a telephony gateway, which includes a line interface for coupling to the telephone line and a data interface for coupling to a packet network, and which is adapted to receive and demodulate the upstream passband signals and to generate and transmit the downstream passband signals to the at least one telephone adapter via the line interface, and which is operative to process the passband signals so as to connect the telephone, via the at least one telephone adapter and the data interface, to communicate over the packet network.

There is additionally provided, in accordance with an embodiment of the present invention, a telephone adapter, including:

a phone connector, for coupling to a telephone;

a line connector, for coupling to a telephone line of a circuit-switched telephone network;

signal processing circuitry, which is operative to modulate output audio signals produced by the telephone in a voice band so as to generate upstream passband signals for transmission in a passband at a frequency higher than the voice band, and to receive and demodulate downstream passband signals so as to generate input audio signals to the telephone; and

a switch, having a first configuration in which the phone connector is connected to the line connector so as to permit the telephone to communicate via the telephone line over the circuit-switched telephone network, and a second configuration in which the signal processing circuitry is connected between the phone connector and the line connector so as to transmit and receive the upstream and downstream passband signals over the telephone line for communication with a packet telephony gateway.

There is further provided, in accordance with an embodiment of the present invention, apparatus for telephony, including:

an audio input/output device;

a line connector, for coupling to a telephone line of a circuit-switched telephone network;

signal processing circuitry, which is operative to modulate output audio signals produced by the audio input/output device in a voice band so as to generate upstream passband signals for transmission in a passband at a frequency higher than the voice band, and to receive and demodulate downstream passband signals so as to generate input audio signals to the audio input/output device; and

a switch, having a first configuration in which the audio input/output device is connected to the line connector so as to communicate directly via the telephone line over the circuit-switched telephone network, and a second configuration in which the signal processing circuitry is connected between the phone connector and the line connector so as to transmit and receive the upstream and downstream passband signals over the telephone line for communication with a packet telephony gateway.

There is moreover provided, in accordance with an embodiment of the present invention, a method for telephony, including:

modulating output audio signals produced by first and second telephones in a voice band so as to generate respective first and second upstream passband signals in a passband at a frequency higher than the voice band;

transmitting the first and second upstream passband signals to a telephony gateway having a data interface;

responsively to receiving the first passband signals at the telephony gateway, coupling the first telephone, using the gateway, to communicate via a telephone line over a circuit-switched telephone network; and

responsively to receiving the second passband signals at the telephony gateway, coupling the second telephone, via the data interface of the telephony gateway, to communicate over a packet network.

There is furthermore provided, in accordance with an embodiment of the present invention, a method for telephony, including:

applying analog modulation to output audio signals produced by a telephone in a voice band so as to generate respective an analog upstream passband signal in a passband at a frequency higher than the voice band;

transmitting the analog upstream passband signal to a telephony gateway having a data interface;

responsively to receiving the analog upstream passband signal at the telephony gateway, coupling the telephone, via the data interface of the telephony gateway, to communicate over a packet network.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a customer premises telephone network, in accordance with an embodiment of the present invention;

FIG. 2 is a block diagram that schematically illustrates a customer premises telephone network, in accordance with another embodiment of the present invention;

FIG. 3 is a power spectral density (PSD) plot, which schematically illustrates an allocation of frequency bands in a customer premises telephone network, in accordance with an embodiment of the present invention;

FIG. 4 is a block diagram that schematically shows details of a telephone adapter, in accordance with an embodiment of the present invention;

FIG. 5 is a block diagram that schematically shows details of a telephony gateway, in accordance with an embodiment of the present invention; and

FIG. 6 is a block diagram that schematically illustrates a customer premises telephone network, in accordance with yet another embodiment of the present invention.

### DETAILED DESCRIPTION OF EMBODIMENTS

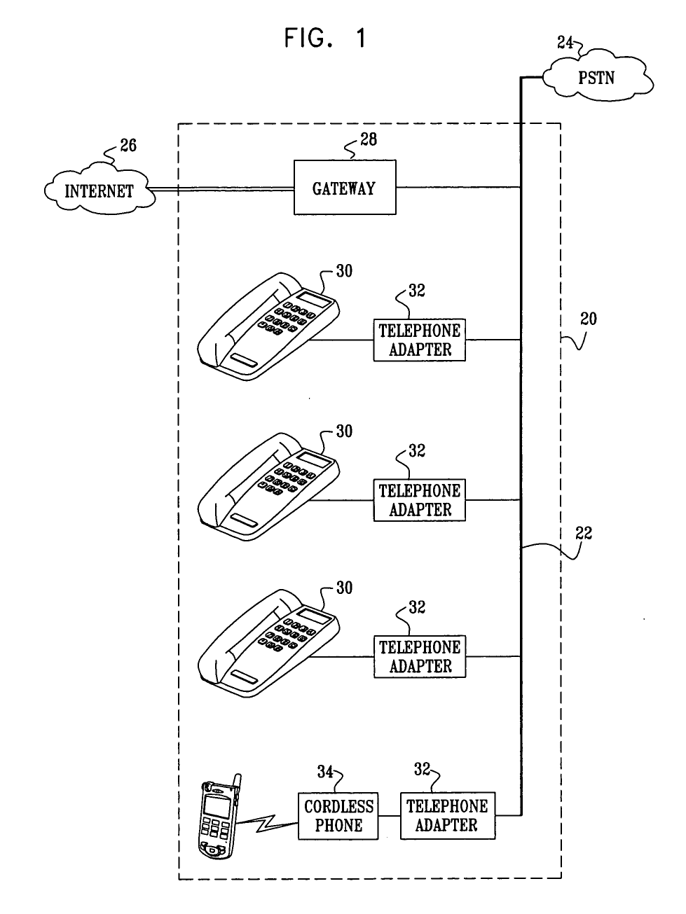

FIG. 1 is a block diagram that schematically illustrates a customer premises telephone network 20, in accordance with an embodiment of the present invention. The premises are wired with a telephone line 22, which is connected to a circuit-switched telephone network, such as a public switched telephone network (PSTN) 24. Line 22 typically comprises wiring in the walls of the customer premises, which may have been used previously for plain old telephone service (POTS) and is exploited in offering upgraded service as described hereinbelow. The wiring may connect the elements of network 20 in substantially any topology, such as the daisy chain topology shown in FIG. 1 or a star topology.

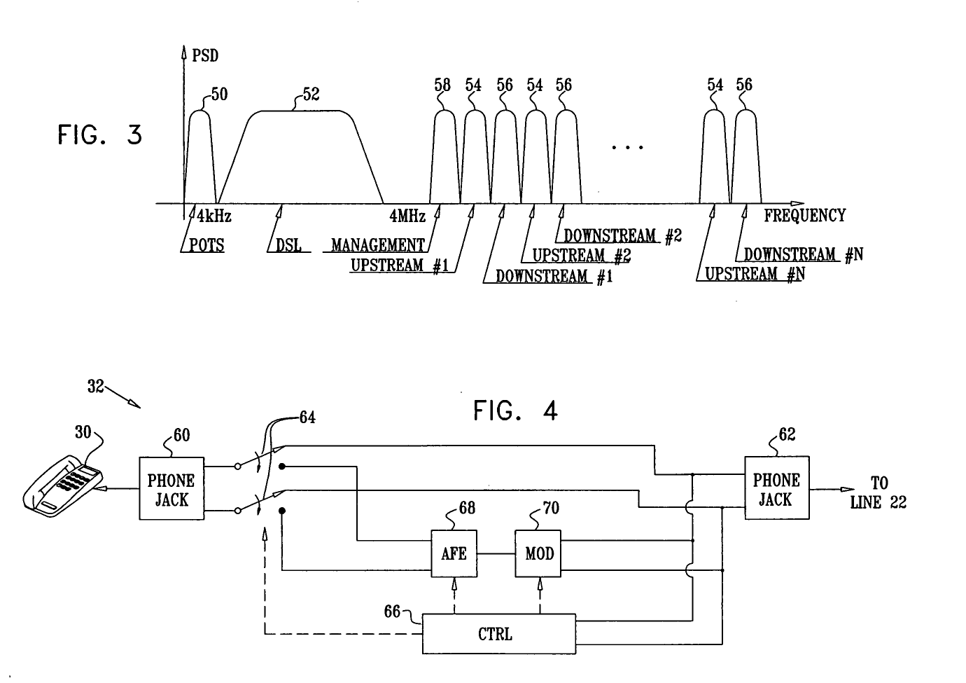

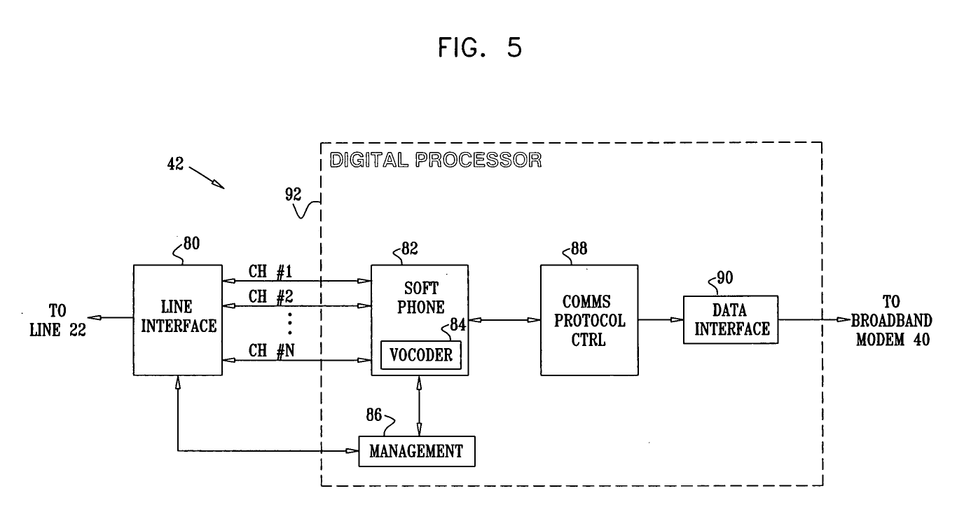

Network 20 uses a gateway 28 to provide both circuit-switched telephone service on PSTN 24 and packet telephone service on a packet network 26, such as VoIP service over the Internet. Details of gateway 28 are shown below in FIG. 5. The gateway communicates with telephones 30 via telephone adapters 32, which are shown in detail in FIG. 4. In the embodiment of FIG. 1, adapters 32 communicate with gateway 28 over telephone line 22 by transmitting and receiving passband signals. Typically, these passband signals are transmitted in a frequency band above the voice band used for PSTN service. Frequency domain multiplexing (FDM) may be used to enable multiple adapters 32 to communicate over line 22 simultaneously, as shown below in FIG. 3. Alternatively, any other suitable multiplexing scheme, such as time domain multiplexing (TDM), may be used for this purpose.

Telephones 30 may comprise conventional analog telephones, which are configured for voice band use. Alternatively or additionally, other types of telephones may be coupled to adapters 32, such as a cordless phone 34. Further additionally or alternatively, adapters 32 may be configured to operate with digital telephones, such as telephones that are designed to plug into a computer USB port or digital telephones used in PBX systems, as are known in the art. Furthermore, although telephones 30 and adapters 32 are shown in the figures as separate units, the functions of the telephone and the adapter may alternatively be combined in an integrated telephone device. Thus, in this context, telephones 30 should be regarded as more generally representing any sort of audio input/output device that may be used in conjunction with the functions of adapter 32. All such alternative implementations will be apparent to those skilled in the art after reading the description that follows and are considered to be within the scope of the present invention.

Gateway 28 and adapters 32 provide a sort of logical, distributed PBX function to the customer premises that are served by network 20. To place an outgoing call, a user typically picks up one of telephones 30 and dials the desired number using the telephone keypad. Adapter 32 conveys the user keystrokes to gateway 28, which then places the call on the PSTN 24 or packet network 26. The user may typically select PSTN or VoIP service either by pressing a certain keystroke or sequence of keystrokes or by operating a button or switch on adapter 32, for example. Alternatively or additionally, gateway 28 may automatically select the type of service depending on the telephone number that the user dials, the availability of the telephone line, and/or other dialing rules. Adapter 32 may generate a special dial tone, which is then played by telephone 30, in order to signal to the user the type of service (PSTN or VoIP) that is available or has been selected by the user. Alternatively, the adapter may signal an off-hook event to the gateway, which then transmits the appropriate dial tone back to the adapter. Additionally or alternatively, if the user of the telephone selects a type of service that is not available, the adapter or gateway may generate a busy signal.

For example, if one user is currently using the telephone line in a call on PSTN 24, the gateway may restrict other users to placing VoIP calls. In this manner, network 20 can be used to carry multiple calls simultaneously, all carried on the same telephone line 22. Although only a single telephone line is shown in FIG. 1, gateway 28 may alternatively be connected to PSTN 24 by two or more lines and may allocate the lines among telephones 30 in a manner similar to a conventional PBX.

Upon receiving an incoming call from either PSTN 24 or packet network 26, gateway 28 signals one or more of adapters 32 to ring the corresponding telephones. When one of the telephones is then picked up by a user, the corresponding adapter signals gateway 28 accordingly, and the gateway completes the call. Gateway 28 typically determines which telephone or telephones to ring based on pre-programmed rules, as in a conventional PBX. In choosing the telephones to ring, the gateway may take into account hook signals from one or more of adapters 32, indicating that the corresponding telephones are off-hook. Alternatively, the gateway may simply ring all available telephones. If an incoming call arrives while the destination telephone is in use, gateway 28 may signal the corresponding adapter 32 to generate a call waiting signal on the telephone or may generate the call waiting tone and transmit it to the adapter.

Gateway 28 may also be configured to carry out other PBX-like functions, such as conferencing. For example, two or more of adapters 32 may be joined to the same PSTN or VoIP call. As another example, the gateway may conference together PSTN and VoIP calls. Additionally or alternatively, the gateway may support internal calls between telephones on network 20.

Optionally, telephone adapters 32 are also capable of connecting telephones 30 directly to line 22. In this configuration, the telephones can then be used to dial and receive calls directly to and from PSTN 24, bypassing the functions of gateway 28. This feature is useful, for example, when the gateway functions are unavailable due to a power failure or a malfunction of the gateway.

As another option, the gateway may be configured to handle only VoIP calls and not PSTN calls. In this case, each adapter 32 is configured to connect the corresponding telephone 30 directly to line 22 whenever the telephone is to be used to place or receive PSTN calls. This optional configuration may be helpful in reducing the hardware complexity and processing demands on the gateway. In this case, the adapter couples the telephone via passband communication to gateway 28 only when the user places an outgoing VoIP call or when the gateway receives an incoming VoIP call.

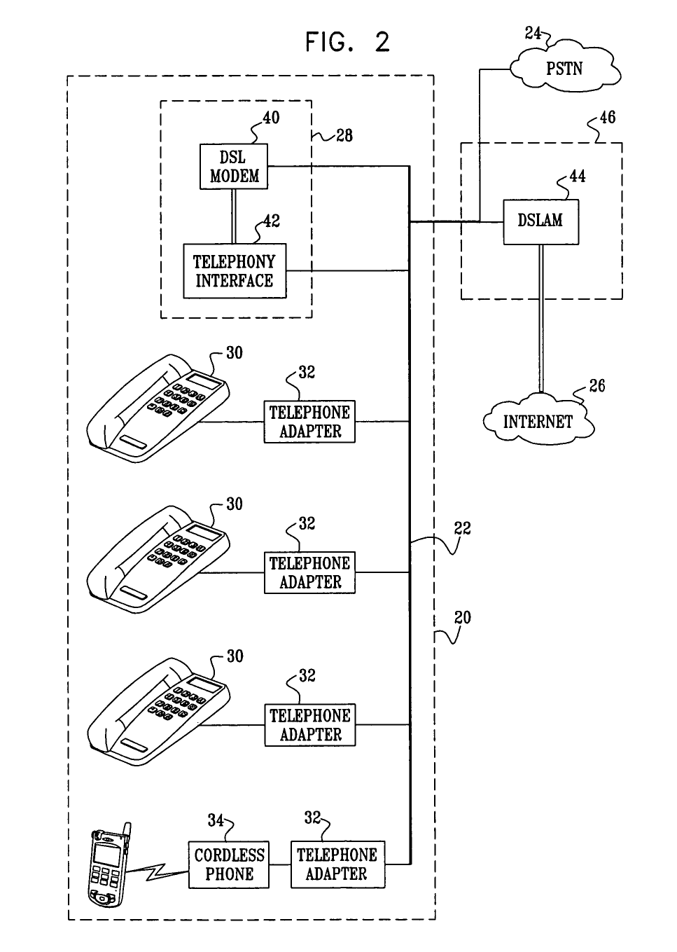

FIG. 2 is a block diagram that schematically shows details of network 20, in accordance with an embodiment of the present invention. In this embodiment, gateway 28 comprises (or is coupled to) a DSL modem 40, which provides broadband access to packet network 26 via telephone line 22. A DSL access multiplexer (DSLAM) in a central office 46 of the telephone service provider exchanges packet communications with DSL modem 40, while voice-band telephone communications are conveyed via the central office to and from PSTN 24. In other words, in this embodiment, line 22 is used for three purposes: voice-band calls to and from PSTN 24; VoIP calls over DSL link to and from packet network 26; and passband communications between telephone adapters 32 and a telephony interface 42 in gateway 28. Functionally, the embodiment of FIG. 2 operates in the manner described above.

Alternatively, gateway 28 may be linked to packet network 26 via broadband links of other types. For example, the gateway may comprise or be connected to a cable modem, for communication via a television cable network, or to an Ethernet local area network (LAN) or wide area network (WAN), or to a wireless network, such as a WiMax network.

FIG. 3 is a power spectral density (PSD) plot showing allocation of frequencies in the network of FIG. 1 or FIG. 2, in accordance with an embodiment of the present invention. A POTS band 50, in the voice-band range below 4 kHz, is allocated for analog telephone communications with PSTN 24. A DSL band 52 is used by modem 40 in communicating with DSLAM 44. In asymmetric DSL (ADSL), for example, band 52 reaches up to about 1.1 MHz, or 2.2 MHz under the newer ADSL2+standard. Alternatively, modem 40 may comply with any other suitable DSL standard.

The passband used for communication between telephone adapters 32 and gateway 28 is divided into multiple sub-bands 54, 56 and 58. Each of telephone adapters 32 is assigned a respective upstream sub-band 54 and downstream sub-band 56 for carrying modulated audio signals to and from the respective telephone 30. The sub-bands may be pre-configured in each adapter, or they may alternatively be allocated dynamically by gateway 28. Typically, sub-bands 54, 56 and 58 occupy frequencies above 4 MHz, as shown in the figure, in order to avoid interference with DSL band 52 and to comply with applicable regulatory requirements regarding permitted frequency uses. Alternatively, these sub-bands may be modulated at higher or lower frequency depending on spectrum availability and regulatory restrictions.

Optionally, a separate management sub-band 58 is allocated for control communications between the gateway and telephone adapters. Sub-band 58 may be used, for example, to convey hook and ring signals between the telephone adapters and the gateway. Although FIG. 3 shows a single management sub-band to be shared by all adapters 32, multiple management sub-bands may alternatively be allocated for communication with different adapters or for other purposes. Further alternatively or additionally, in-band signaling may be carried in the respective upstream and downstream sub-bands 54 and 56 of each adapter.

FIG. 4 is a block diagram that schematically shows details of adapter 32, in accordance with an embodiment of the present invention. The adapter comprises a phone jack 60, for connecting to telephone 30, and a line jack 62, for connecting to line 22. (The term “jack” should be understood to refer to any sort of suitable connector, and is not limited to a particular type or types of standard telephone plugs.) Switches 64 determine the operating configuration of adapter 32, under the command of a controller 66. In the upper position of switches 64 that is shown in FIG. 4, the switches connect phone jack 60 directly to line jack 62, so that telephone 30 can place and receive calls directly to and from PSTN 24, without the intervention of gateway 28. In the lower position, signals to and from telephone 30 are processed by signal processing circuitry that comprises an analog front end (AFE) 68 and a modulator 70, whose functions are described further hereinbelow.

The functional makeup of adapter 32 that is shown in FIG. 4 is simplified for the sake of conceptual clarity. In practice, adapter 32 typically comprises other elements, such as a power supply, as will be apparent to those skilled in the art. The power supply may draw electrical power from telephone line 22, or it may alternatively comprise a battery, a DC wall adapter, or an AC line connection.

Controller 66 typically receives instructions from gateway 28 (via management sub-band 58, for example, as shown in FIG. 3), and sets switches 64 accordingly. Alternatively or additionally, switches 64 may be set manually by a user of telephone 30 or by input of a certain keystroke sequence, which is sensed by controller 66. In case of a power failure or other malfunction, switches 64 may default to the upper position, as shown in FIG. 4, to enable the user to communicate with PSTN 24.

AFE 68 receives analog audio signals from telephone 30 and may filter and amplify the signals as appropriate. Optionally, although not necessarily, the AFE digitizes the signals. A modulator 70 then up-converts the signals (analog or digital) to the upstream sub-band 54 that is assigned to this adapter. When AFE 68 outputs analog signals, modulator 70 may apply, for example, frequency modulation (FM), amplitude modulation (AM), single- or double-side band modulation, or any other suitable analog modulation scheme known in the art. When AFE 68 digitizes the signals, the modulator may apply, for example, frequency shift keying (FSK), phase shift keying (PSK), quadrature amplitude modulation (QAM), or any other suitable digital modulation scheme known in the art. Such digital modulation schemes may also be used in management sub-band 58. In downstream sub-band 56, modulator 70 down-converts signals from line 22 to the audio range, and AFE 68 then conveys the audio signals to telephone 30 (after digital/analog conversion, if required, and filtering and amplification as appropriate). Analog modulation of the upstream and downstream audio signals, in combination with an FDM scheme such as that shown in FIG. 3, is advantageous in that it reduces the hardware complexity and cost of adapters 32 in comparison with solutions that are based on digital modulation and transmission schemes.

Typically, AFE 68 also carries out other telephone-related functions, as are known in the art, such as hook detection, ring generation, and supplying power to telephone 30 when the telephone is off hook. The AFE and other elements of adapter 32 may also be configured to carry out more sophisticated detection and control functions, such as those described in U.S. patent application Ser. No. 11/211,361, filed Aug. 25, 2005, and in U.S. patent application Ser. No. 11/243,135, filed Oct. 25, 2004. Both of these applications are assigned to the assignee of the present patent application, and their disclosures are incorporated herein by reference.

FIG. 5 is a block diagram that schematically shows details of telephony interface 42 in gateway 28, in accordance with an embodiment of the present invention. As in the case of FIG. 4, this is a simplified, functional view and omits details and peripheral components that are not essential to an understanding of the present invention. Interface 42 comprises a line interface 80, which is coupled to telephone line 22, and a digital processor 92. The digital processor may comprise a general-purpose computer, which is programmed in software to carry out the functions described herein. Alternatively, digital processor 92 may comprise a dedicated microprocessor and/or dedicated processing hardware. This processor may be packaged as a standalone device or, alternatively, integrated in a single package with modem 40 or with any other suitable device with an embedded processor. The blocks shown within processor 92 in FIG. 5 represent functional elements, which may be implemented in hardware or in software on a microprocessor. Optionally, a telephone adapter may also be integrated in the gateway package, thus permitting a telephone to be connected directly to the gateway.

Line interface 80 comprises demodulation, modulation and switching circuits (not shown) for handling transmission and reception of passband signals in sub-bands 54, 56 and 58. The modulation and demodulation may take place in either the analog or the digital domain, depending on the type of modulation used by adapters 32. For example, assuming the adapters use analog modulation, line interface 80 may apply analog demodulation to the passband signals in order to recover the upstream voice-band audio signals. When one of telephones 30 is used on a PSTN call via gateway 28, line interface 80 switches the voice-band audio signals (demodulated from the appropriate upstream sub-band) out onto line 22 for transmission to PSTN 24. Line interface 80 similarly modulates and switches the incoming audio signals from PSTN 24 for transmission over line 22 in the appropriate downstream sub-band. In addition, line interface 80 emulates functions of a conventional telephone, such as hook, ring and dialing functions, so as to enable gateway 28 to place outgoing calls and receive incoming calls.

For VoIP calls, line interface 80 digitizes the demodulated voice-band audio signals from telephone adapters being used in such calls for input to digital processor 92, and similarly receives digital sample streams from the digital processor for modulation and transmission in downstream audio signals to the respective telephone adapters.

Alternatively, line interface 80 may apply digital modulation and demodulation to the passband signals. (In this case, line interface 80 also performs digital/analog and analog/digital conversion in conjunction with transmission and reception of audio signals to and from PSTN 24.) Digital modulation and demodulation are called for, of course, if telephone adapters 32 digitize the telephone audio signals, as described above. In addition, line interface 80 may first digitize the upstream passband signals on line 22 using a high-speed analog/digital converter, and may then convey the digital samples to digital processor 92 for demodulation and separation into sub-band signals. The downstream passband signals may similarly be generated in the digital domain and then converted to analog signals using a suitable digital/analog converter.

Regardless of the modulation scheme (analog or digital) that is used, line interface 80 conveys up to N channels of upstream digital audio data to digital processor 92, corresponding to the upstream signals received in sub-bands 54, and receives up to N channels of downstream audio data from the digital processor for transmission as downstream signals in sub-bands 56. These digital sample streams are indicated as channels 1 through N (CH#1, CH#2, . . . , CH#N) in FIG. 5. An additional sample stream carries traffic in management sub-band 58 to and from a management processor 86. (Although the management processor is shown and referred to as a separate entity from other elements of digital processor 92, it may be implemented simply as an additional software process running on a microprocessor that also carries out other functions of the digital processor.) The number of sample streams N may be equal to the number of telephone adapters 32 in network 20. Alternatively, in order to save bandwidth and processing resources, the number of channels may be less than the number telephone adapters, and channels may be allocated as required to adapters 32 by management processor 86 for placing and receiving calls to and from networks 24 and 26.

A soft phone application 82 processes the digital audio channels and management commands from processor 86 in order to place and receive VoIP calls on packet network 26. The soft phone application comprises a vocoder 84 for encoding the upstream digital audio samples to be transmitted on each packet call in the appropriate format, such as G.711 or G.723.1, and for decoding incoming audio packets to generate downstream digital audio samples. The soft phone application also processes and generates call setup and control packets in accordance with the appropriate protocol, such as the Session Initiation Protocol (SIP), H.323, or Skype™.

The VoIP audio and signaling packets produced by soft phone application 82 are encapsulated and transmitted in IP packets using a standard network protocol stack, such as TCP/IP or UDP/IP, under control of a communications protocol controller 88 (which may also be implemented as a software process). The packets are conveyed to and from modem 40 via a data interface 90. The data interface may comprise, for example, a USB port or Ethernet connection, a computer bus interface, or a combination of such elements, depending on the hardware configuration of gateway 28.

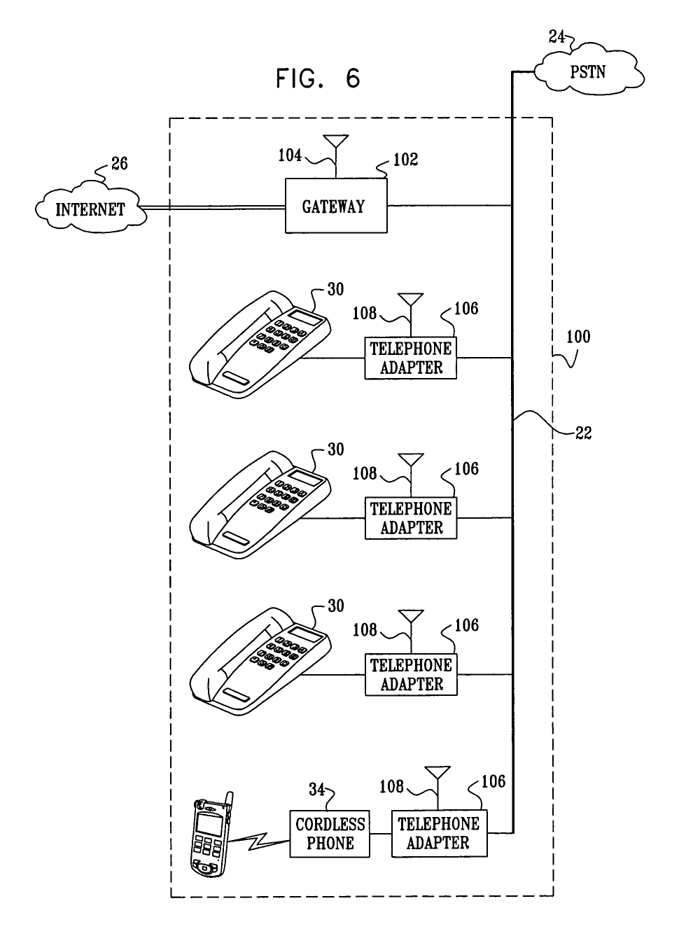

FIG. 6 is a block diagram that schematically illustrates a customer premises telephone network 100, in accordance with another embodiment of the present invention. This embodiment is functionally similar to the embodiment shown in FIG. 1 and described above. In FIG. 6, however, a gateway 102 and telephone adapters 106 exchange modulated passband signals over the air via respective wireless interfaces 104 and 108, rather than over telephone line 22. The wireless interfaces may operate in accordance with a standard wireless LAN protocol, such as IEEE 802.11, or they may alternatively use a proprietary protocol. Use of wireless transmission in this manner permits the bandwidth on telephone line 22 to be used for other purposes.

In the embodiment shown in FIG. 6, adapters 106 are connected to telephone line 22 in order to permit telephones 30 to transmit and receive voice-band signals to and from PSTN 24 independently of gateway 102. As noted earlier, this direct access to the PSTN is useful when the gateway is non-functional or unavailable for some reason, and may also be used as a default for PSTN access in order to simplify the hardware and processing demands on the gateway. Alternatively, the telephone adapters may have no direct telephone line connection, so that the telephones operate only via the wireless connection to gateway 102 (which is connected to telephone line 22). This latter arrangement permits the telephones and adapters to be deployed anywhere in the customer premises, without dependence on the wiring.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A system for telephony, comprising:
a plurality of telephone adapters, each of which is configured to be coupled to a telephone and to modulate output audio signals produced by the telephone in a voice band so as to generate upstream passband signals for transmission in a passband at a frequency higher than the voice band, and to receive and demodulate downstream passband signals so as to generate input audio signals to the telephone; and
a telephony gateway, which is adapted to receive and demodulate the upstream passband signals and to generate and transmit the downstream passband signals to the telephone adapters, and which comprises a line interface for coupling to a telephone line of a circuit-switched telephone network and a data interface for coupling to a packet network, and which is operative to process the passband signals so as to couple a first telephone, via a first telephone adapter and the telephone line, to communicate over the circuit-switched telephone network, while coupling a second telephone, via a second telephone adapter and the data interface, to communicate over the packet network.

2. The system according to claim 1, wherein the telephone adapters are arranged to be coupled to the telephone line, and are operative to exchange the upstream and downstream passband signals with the telephony gateway via the telephone line.

3. The system according to claim 2, wherein each of the telephone adapters comprises a respective switch, which is operable to connect the telephone to the telephone line so as to permit the telephone to communicate over the circuit-switched network by conveying the input and output audio signals between the telephone and the telephone line.

4. The system according to claim 1, wherein the telephony gateway is operative to couple the first telephone to communicate over the circuit-switched network via the line interface of the telephone gateway.

5. The system according to claim 1, wherein the telephony gateway is operative to establish a Voice over Internet Protocol (VoIP) call between the second telephone and the packet network.

6. The system according to claim 1, wherein the telephone adapters and the telephony gateway are adapted to transmit and receive the upstream and downstream passband signals over the air.

7. The system according to claim 1, wherein the upstream and downstream passband signals are modulated using an analog modulation scheme.

8. The system according to claim 1, wherein the telephony gateway comprises a digital subscriber line (DSL) modem, which is coupled between the data interface and the telephone line and is operative to connect the telephony gateway to the packet network by transmitting and receiving DSL signals over the telephone line.

9. The system according to claim 8, wherein the DSL modem is operative to transmit and receive the DSL signals in a DSL frequency band, and wherein the telephone adapters are operative to exchange the upstream and downstream passband signals with the telephony gateway via the telephone line, such that the frequency of the passband in which the telephone adapters and the telephony gateway transmit the upstream and downstream passband signals is higher than the DSL frequency band.

10. The system according to claim 1, wherein the passband comprises at least first and second sub-bands, which are respectively assigned to the first and second telephone adapters for use in communicating simultaneously with the telephony gateway.

11. A system for telephony, comprising:
at least one telephone adapter, which is configured to be coupled to a telephone and to a telephone line of a circuit-switched telephone network, and which comprises:
signal processing circuitry, which is operative to modulate output audio signals produced by the telephone in a voice band so as to generate upstream passband signals for transmission in a passband at a frequency higher than the voice band, and to receive and demodulate downstream passband signals so as to generate input audio signals to the telephone; and
a switch, having a first configuration in which the telephone is connected to the telephone line so as to permit the telephone to communicate via the telephone line over the circuit-switched telephone network, and a second configuration in which the signal processing circuitry is connected between the telephone and the telephone line so as to transmit and receive the upstream and downstream passband signals over the telephone line; and
a telephony gateway, which comprises a line interface for coupling to the telephone line and a data interface for coupling to a packet network, and which is adapted to receive and demodulate the upstream passband signals and to generate and transmit the downstream passband signals to the at least one telephone adapter via the line interface, and which is operative to process the passband signals so as to connect the telephone, via the at least one telephone adapter and the data interface, to communicate over the packet network.

12. The system according to claim 11, wherein the telephony gateway comprises a digital subscriber line (DSL) modem, which is coupled between the data interface and the telephone line and is operative to connect the telephony gateway to the packet network by transmitting and receiving DSL signals over the telephone line.

13. The system according to claim 12, wherein the DSL modem is operative to transmit and receive the DSL signals in a DSL frequency band, and wherein the frequency of the passband in which the telephone adapters and the telephony gateway transmit the upstream and downstream passband signals is higher than the DSL frequency band.

14. The system according to claim 11, wherein the upstream and downstream passband signals are modulated using an analog modulation scheme.

15. A telephone adapter, comprising:
a phone connector, for coupling to a telephone;
a line connector, for coupling to a telephone line of a circuit-switched telephone network;
signal processing circuitry, which is operative to modulate output audio signals produced by the telephone in a voice band so as to generate upstream passband signals for transmission in a passband at a frequency higher than the voice band, and to receive and demodulate downstream passband signals so as to generate input audio signals to the telephone; and
a switch, having a first configuration in which the phone connector is connected to the line connector so as to permit the telephone to communicate via the telephone line over the circuit-switched telephone network, and a second configuration in which the signal processing circuitry is connected between the phone connector and the line connector so as to transmit and receive the upstream and downstream passband signals over the telephone line for communication with a packet telephony gateway.

16. The apparatus according to claim 15, wherein the upstream and downstream passband signals are modulated using an analog modulation scheme.

17. Apparatus for telephony, comprising:
an audio input/output device;
a line connector, for coupling to a telephone line of a circuit-switched telephone network;
signal processing circuitry, which is operative to modulate output audio signals produced by the audio input/output device in a voice band so as to generate upstream passband signals for transmission in a passband at a frequency higher than the voice band, and to receive and demodulate downstream passband signals so as to generate input audio signals to the audio input/output device; and
a switch, having a first configuration in which the audio input/output device is connected to the line connector so as to communicate directly via the telephone line over the circuit-switched telephone network, and a second configuration in which the signal processing circuitry is connected between the phone connector and the line connector so as to transmit and receive the upstream and downstream passband signals over the telephone line for communication with a packet telephony gateway.

18. The apparatus according to claim 17, wherein the upstream and downstream passband signals are modulated using an analog modulation scheme.

19. A method for telephony, comprising:
modulating output audio signals produced by first and second telephones in a voice band so as to generate respective first and second upstream passband signals in a passband at a frequency higher than the voice band;
transmitting the first and second upstream passband signals to a telephony gateway having a data interface;
responsively to receiving the first passband signals at the telephony gateway, coupling the first telephone, using the gateway, to communicate via a telephone line over a circuit-switched telephone network; and
responsively to receiving the second passband signals at the telephony gateway, coupling the second telephone, via the data interface of the telephony gateway, to communicate over a packet network.

20. The method according to claim 19, wherein transmitting the first and second upstream passband signals comprises transmitting the upstream passband signals to the telephony gateway via the telephone line.

21. The method according to claim 20, wherein coupling the first telephone comprises connecting the first telephone via a telephone adapter to the telephone line so that the telephone adapter conveys the output audio signals from the telephone to the telephone line.

22. The method according to claim 19, wherein coupling the first telephone comprises demodulating the first upstream passband signals at the telephony gateway so as to recover the output audio signals, and transmitting the recovered output audio signals over the circuit-switched network via a line interface of the telephony gateway.

23. The method according to claim 19, wherein coupling the second telephone comprises establishing a Voice over Internet Protocol (VoIP) call between the second telephone and the packet network via the telephony gateway.

24. The method according to claim 19, wherein transmitting the first and second upstream passband signals comprises transmitting the upstream passband signals to the telephony gateway over the air.

25. The method according to claim 19, wherein modulating the output audio signals comprises applying an analog modulation scheme to the output audio signals.

26. The method according to claim 19, wherein coupling the second telephone comprises communicating with the packet network over the telephone line using a digital subscriber line (DSL) modem.

27. The method according to claim 26, wherein communicating using the DSL modem comprises transmitting DSL signals in a DSL frequency band, and wherein transmitting the first and second upstream passband signals comprises transmitting the passband signals via the telephone line, such that the frequency of the passband in which the passband signals is transmitted is higher than the DSL frequency band.

28. The method according to claim 19, wherein the passband comprises at least first and second upstream sub-bands, which are respectively assigned to the first and second telephones for use in communicating simultaneously with the telephony gateway.

29. The method according to claim 28, and comprising transmitting downstream passband signals from the telephony gateway to the telephones in at least first and second downstream sub-bands.

30. A method for telephony, comprising:
applying analog modulation to output audio signals produced by a telephone in a voice band so as to generate respective an analog upstream passband signal in a passband at a frequency higher than the voice band;
transmitting the analog upstream passband signal to a telephony gateway having a data interface;
responsively to receiving the analog upstream passband signal at the telephony gateway, coupling the telephone, via the data interface of the telephony gateway, to communicate over a packet network.
